(19) United States
(12) Patent Application Publication
(10) Pub. No.: US 2017/0185993 A1
(43) Pub. Date: Jun. 29, 2017

(54) MOBILE NEAR FIELD COMMUNICATION PAYMENT FOR BANKING ACTIVITIES FROM AN AUTOMATED TELLER MACHINE

(71) Applicant: CA, Inc., New York, NY (US)

(72) Inventors: Yashwant Ramkishan Sawant, Bangalore (IN); Mohammed Mujeeb H. Kaladgi, Bangalore (IN); Mahesh M. Chitragar, Bangalore (IN)

(21) Appl. No.: 14/979,817

(22) Filed: Dec. 28, 2015

(51) Int. Cl. G06Q 20/32; G06Q 20/22; G06Q 20/10

(52) U.S. Cl. CPC G06Q 20/3278; G06Q 20/1085; G06Q 20/3223; G06Q 20/22

(57) ABSTRACT

A user interface of an automated teller machine receives a first input that identifies a transaction type. Next, a near field communication reader of the ATM detects a first near field communication message from a first mobile device so that the automated teller machine can extract a first account identification information from that message. The first account identification information comprises data related to a first account associated with a first user. A second NFC message from a second mobile device associated with a second user is detected in order to extract a second account identification information from the second NFC message. The second account identification information comprises data related to a second account associated with the second user. Once the ATM has the needed information, it can initiate a transaction based on the transaction type, the first account identification information, and the second account identification information.

### BACKGROUND

The present disclosure relates to mobile devices and, more specifically, to mobile devices capable of near field communication.

Near field communication (NFC) refers to radio communication over short distances and has come to be used in most cases for a specific set of protocols that enable two electronic devices, one of which is usually a portable device such as a smartphone, to establish radio data communication with each other by bringing them closer than, typically, 10 cm (4 in) from each other. NFC-enabled portable devices can be provided with apps, for example to read electronic tags or otherwise communicate when connected to any NFC-compliant apparatus. Like other ‘proximity card’ technologies, NFC employs electromagnetic induction between two loop antennae when NFC devices—for example a ‘smartphone’ and a ‘smart poster’—exchange information, operating within the globally available unlicensed radio frequency ISM band of 13.56 MHz on ISO/IEC 18000-3 air interface at rates ranging from 106 to 424 kbit/s.

Each full NFC device can work in three modes: NFC Card Emulation; NFC Reader/Writer; and NFC peer-to-peer (P2P mode). NFC Card emulation mode enables NFC-enabled devices such as smartphones to act like smart cards, allowing users to perform transactions such as payment or ticketing. NFC Reader/writer mode enables NFC-enabled devices to read information stored on inexpensive NFC tags embedded in labels or smart posters. NFC peer-to-peer mode enables two NFC-enabled devices to communicate with each other to exchange information in an adhoc fashion.

There are two NFC communication modes. In the passive communication mode, the initiator device provides a carrier field and the target device answers by modulating the existing field. In this mode, the target device may draw its operating power from the initiator-provided electromagnetic field, thus making the target device a transponder. In the active communication mode, both initiator and target device communicate by alternately generating their own fields. A device deactivates its RF field while it is waiting for data. In this mode, both devices typically have power supplies.

As more mobile devices are designed to be NFC-enabled, such devices can be utilized to improve more types of daily activities for users of the devices.

### BRIEF SUMMARY

According to one aspect of the present disclosure, a method includes receiving, via a user interface of an automated teller machine (ATM), a first input that identifies a transaction type. Next, a near field communication (NFC) reader of the automated teller machine detects a first near field communication message from a first mobile device associated with a first user so that the automated teller machine can extract a first account identification information from the first near field communication message. In particular, the first account identification information comprises data related to a first account associated with the first user. The automated teller machine can also receive, via the user interface, a second input that indicates a transaction amount. The method continues with detection of a second near field communication message from a second mobile device associated with a second user in order to extract a second account identification information from the second near field communication message. In particular, the second account identification information comprises data related to a second account associated with the second user. Once the automated teller machine has the needed information, it can initiate a transaction based on the transaction type, the first account identification information, and the second account identification information. In some embodiments, the initiated transaction can also be based on the received transaction amount as well.

According to another aspect of the present disclosure, a system includes a user interface, a near field communication reader, a processor and a memory that stores executable code for the processor to execute. In particular, the user interface is configured to provide user-selectable options; receive a first input that identifies a transaction type; and optionally receive a second input that identifies a transaction amount. The near field communication reader is configured to detect a first near field communication message from a first mobile device associated with a first user; and detect a second near field communication message from a second mobile device associated with a second user. The executable code when executed causes the processor to: a) extract a first account identification information from the first near field communication message that identifies a first account associated with the first user; b) extract a second account identification information from the second near field communication message that identifies a second account associated with the second user; and c) initiate a transaction based on the transaction type, the first account identification information, and the second account identification information. The transaction can also be based on the transaction amount if received through the interface.

According to another aspect of the present disclosure, a computer program product for operating an automated teller machine includes a non-transitory computer readable storage medium having computer readable program code embodied therewith. The computer readable program code includes computer readable program code for receiving, via a user interface of an automated teller machine, a first input that identifies a transaction type. The computer readable program code also includes computer readable program code for detecting, by a near field communication reader of the automated teller machine, a first near field communication message from a first mobile device associated with a first user so that the automated teller machine can extract a first account identification information from the first near field communication message. In particular, the first account identification information comprises data related to a first account associated with the first user. The computer readable program code can also include computer readable program code for receiving, via the user interface, a second input that indicates a transaction amount. The computer program code can also detect a second near field communication message from a second mobile device associated with a second user in order to extract a second account identification information from the second near field communication message. In particular, the second account identification information comprises data related to a second account associated with the second user. The computer readable program code also includes computer readable program code for initiating a transaction based on the transaction type, the first account identification information, and the second account identification information. In some embodiments, the initiated transaction can also be based on the received transaction amount as well.

### BRIEF DESCRIPTION OF THE DRAWINGS

Aspects of the present disclosure are illustrated by way of example and are not limited by the accompanying figures with like references indicating like elements.

FIG. 1 illustrates a flowchart of NFC devices interacting with an ATM to initiate a transaction in accordance with the principles of the present disclosure.

FIG. 2A and FIG. 2B illustrate a flowchart of an ATM performing a transaction in accordance with the principles of the present disclosure.

FIG. 3 illustrates an example hardware environment in accordance with the principles of the present disclosure.

FIG. 4 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or by combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In accordance with the principles of the present disclosure, an ATM or a method of operating an ATM involves near field communication with two mobile devices in order to construct a transaction that the ATM can then perform. One example “transaction type” that the first user can select relates to adding a beneficiary for an inter-bank transfer. In this example, a first near field communication message from a first mobile device can include an identifier (e.g., a phone number) associated with the first mobile device along with a unique personal identification number (PIN) known by the first user. A bank with which the automated teller machine communicates can use the mobile device phone number and the PIN to identify a specific first bank account. A second near field communication message from a second user of a second mobile device can include the information that typically is needed to identify a beneficiary. This information, for example, can include a beneficiary name, a beneficiary address, a beneficiary account number, an account type associated with that account, and identifying code associated with the particular bank branch of the beneficiary. Using this information, the automated teller machine can send instructions to a bank or other transaction clearinghouse to associate the beneficiary information with the first bank account. Thus, because of the communication between the automated teller machine and the two mobile devices, all the data for adding a beneficiary's information can be provided without the need to type or otherwise enter the information into the automated teller machine. Furthermore, the transaction is accomplished without needing an Internet connection or network-enabled devices.

Another transaction type that the first user can select relates to performing an inter-bank fund transfer. This type of transaction can occur between the first user's bank account and any beneficiaries that have been previously identified and associated with this account. In this example, the communications between the automated teller machine and the two mobile devices is essentially the same as that described above. However, instead of the automated teller machine initiating a transaction that merely adds the beneficiary information, the automated teller machine initiates a transaction that will result in an amount of funds being debited from the first bank account and credited to the beneficiary's bank account. Thus, because of the communication between the automated teller machine and the two mobile devices, all the information performing an inter-bank transfer can be provided without the need to type or otherwise enter the information into the automated teller machine. Furthermore, the transaction is accomplished without needing an Internet connection or network-enabled devices.

A third type of transaction relates to rewarding a referrer of banking products to friends and family, for example. In this type of transaction, a user utilizes the interface of the ATM to open a new account and enters all the details for that new account. Once that account is open the user can select an option from the ATM interface add, or identify, the person (i.e., the “referral”) who referred the new account holder. The referral opens the NFC app on their mobile device and then taps the mobile device across the NFC circuitry of the ATM to provide account identification information about the referral. This account identification information can then be used by a bank to reward the referral according to a pre-arranged formula.

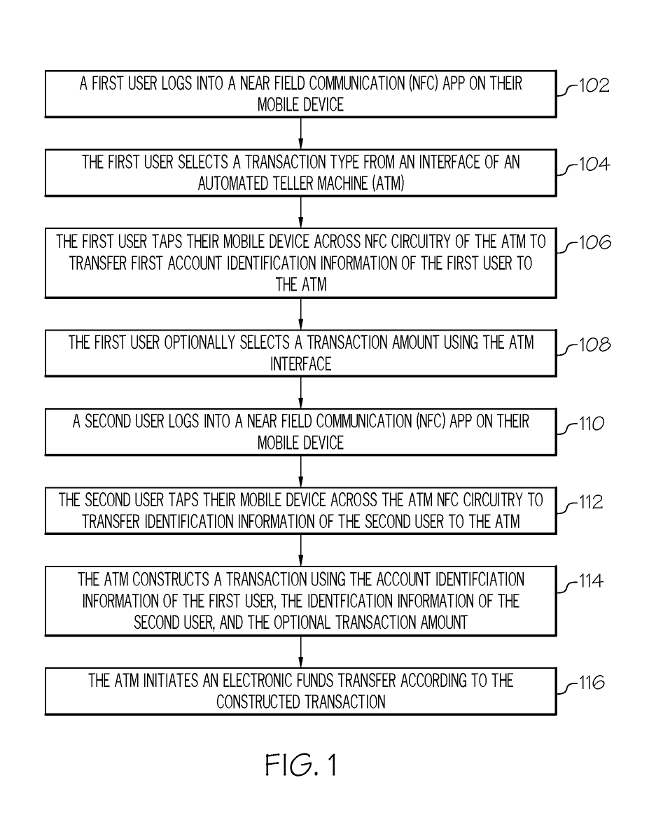

FIG. 1 illustrates a flowchart of NFC devices interacting with an ATM to initiate a transaction in accordance with the principles of the present disclosure. Typically, the ATM will be associated with a financial institution in which the user has an account or the ATM may be connected via a network link or other communications channel to a network that allows the ATM to communicate with the financial institution in which the user has an account. One of ordinary skill will recognize that the steps shown in FIG. 1 may be performed in a different order and still accomplish the intended result. A user with a mobile device can approach an ATM and interact with the ATM using the mobile device. As an initial step, in step 102, the user can log into a NFC app executing on the mobile device such as, for example, by selecting an app icon and then providing a password or personal identification number (PIN) that is known by the user. The app can provide the mobile device with the ability to transmit and receive data via one or more different NFC protocols with other NFC-enabled devices.

In step 104, the user selects from different options available on a user interface provided by the ATM. The user interface of the ATM may include a touch screen or mechanical buttons that allow the user to traverse different menus and options. In particular, the user can use the ATM's user interface to select a type of transaction that the user wishes to perform. One example transaction, as described briefly above, is to enter beneficiary information and associate it with the user's account. Another transaction that can be performed can be to initiate a bank-to-bank transfer of funds from the user's account to a beneficiary's account.

Accordingly, in step 106, the user taps their mobile device across NFC circuitry that is within the ATM. In this way, the mobile device and the ATM can communicate using NFC messages or packets. In particular, the mobile device can provide information to the ATM that identifies an account, such as a bank account, associated with the user of the mobile device. As one example, the account identification information sent by the mobile device can involve the mobile phone number associated with the mobile device and an account number associated with that mobile number. The account number may include a portion that identifies a bank, or financial institution, and a separate portion that identifies an account at that financial institution. A PIN number or other password could also be included as part of sending the account identification information. One of ordinary skill will recognize that there are a variety of different ways that the account identification information sent by the mobile device can be formatted so as to uniquely identify a bank account that is associated with the mobile device and the user of the mobile device.

If the transaction type that the user selected involves a transaction amount, then the user, in step 108, can use the ATM interface to select an amount for the transaction. For example, for an inter-bank transfer, the user can select an amount of money to be debited from the user's account and transferred to an account associated with a beneficiary.

In steps 110 and 112 a second user interacts with the ATM using a mobile device associated with the second user. The second user, for example, can be a beneficiary that has an account that can receive funds transferred from the user's account. In particular, the second user can in step 110 log into an NFC app on their mobile device and then tap their mobile device across the NFC circuitry of the ATM. In this way, the second user can use their mobile device to transfer identification information about the second user to the ATM. The NFC app on the mobile device of the second user can send information pre-stored information on the mobile device that identifies the second user and may also identify a particular bank account associated with the second user. For example, the identification information sent in step 112 can include a beneficiary name, a beneficiary address, a beneficiary account number, a beneficiary account type, and a code that identifies a bank branch of the beneficiary. Alternatively, the identification information sent by the second user's mobile device can include an account or user identifier that the ATM can use to look up additional information in a database of account holders.

Accordingly, the details about a beneficiary can be sent to the ATM using the NFC capabilities of the second user's mobile device. This eliminates the need for either the first user or the second user from typing in all of the information while present at the ATM. Also, the need for the first user to have access to a secure internet connection to perform this transaction is eliminated.

In step 114, the ATM constructs a transaction based on the selected transaction type, the account identification information of the first user and the identification information of the second user. In the case of adding a beneficiary to an account, the ATM constructs a transaction that can be transmitted to another computer of the financial institution or a transaction clearinghouse that can carry out the transaction. In particular, the transaction performed is that the beneficiary information is associated with the first user's account. Thus, in the future, a funds transfer can be performed that transfers funds from the first user's account to the beneficiary's account. In the case that the transaction is a transfer request, then the transaction that is constructed by the ATM involves a request to transfer funds from the first user's account to the beneficiary's account (i.e., the second user). Thus, in step 116, the ATM can initiate the requested transaction. The ATM may not be designed to perform the transaction itself but instead simply transmit the transaction to another computer or clearinghouse that actually performs the transaction.

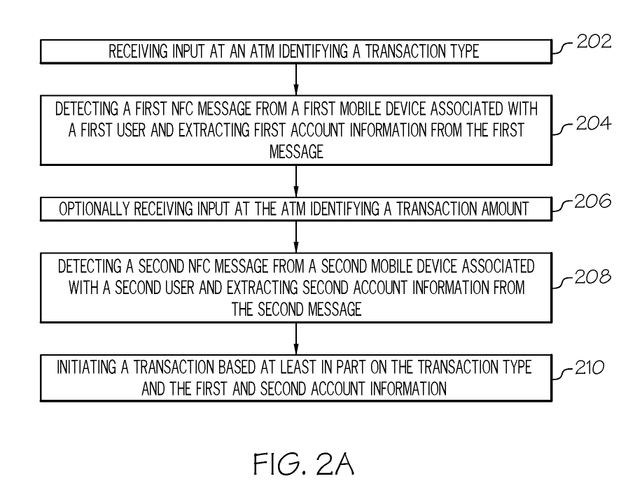

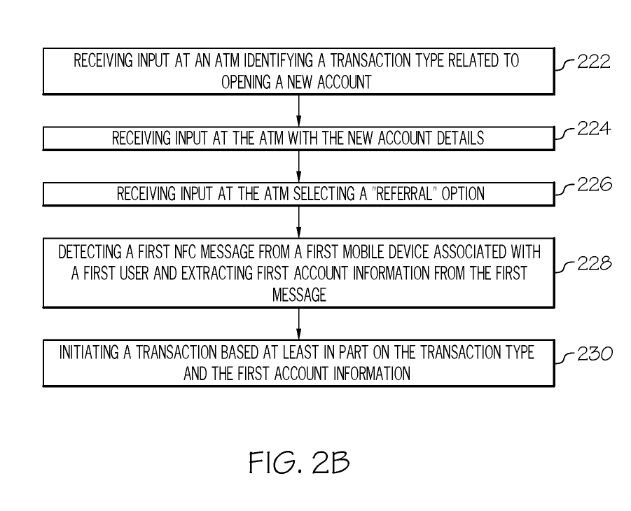

FIG. 2A and FIG. 2B illustrate a flowchart of an ATM performing a transaction in accordance with the principles of the present disclosure. From the perspective of the ATM, it receives, in step 202, input from an ATM user interface that selects or identifies a desired transaction type. Next, in step 204, NFC circuitry of the ATM detects a first message that is transmitted from a first NFC-enabled device. The ATM can then operate to extract information from this first NFC message such that an account of a user associated with the first NFC-enabled device can be identified.

The ATM, for some transactions, may also receive at its user interface a transaction amount, in step 206. Next, in step 208, the NFC circuitry of the ATM can detect a second message that is transmitted from a second NFC-enabled device associated with a second user. The ATM can extract information from the second message that may identify the second user, may identify an account (e.g., bank account) associated with the second user, or may identify both the user and the account. As described earlier, the second message may include this information explicitly or include enough information that the ATM can use to search a database to find an appropriate record that contains the information about the user and the account.

In step 210, the ATM can then initiate a transaction that is based on the transaction type and the information that is extracted from the first and second messages. If the transaction involves a transaction amount, then that can be utilized by the ATM as well when initiating the transaction.

FIG. 2B illustrates a flowchart of a transaction that involves a referrer of services offered by a financial institution. For example, the ATM may be associated with a financial institution and allow a user of the ATM to open a bank account with that institution. Thus, in step 222, the ATM can receive, at its user interface, information from the user that indicates the user would like to open a new account. Furthermore, in step 224, the user continues by providing the ATM with the details that the financial institution will use to open the new account.

After the new account is opened, the first user can select on option offered by the ATM's user interface to provide “referral” information. The financial institution may, for example, track and/or reward customers that refer new customers to the financial institution or refer new products and services to existing customers. Thus, in step 228, the NFC circuitry of the ATM can detect a first message that is sent from an NFC-enabled device associated with a “referral”. The ATM can then extract information from the first message that allows the ATM to identify an account associated with the user of the NFC-enabled device. Accordingly, in step 230, the ATM can initiate a transaction that involves the account of the referrer. For example, based on the type of account opened in step 222, a particular reward amount or other incentive can be credited to the account that is identified in the message sent from the NFC-enabled device. The account could, as already mentioned, be an account at the financial institution. Alternatively, the account could be an account associated with the phone number of the NFC-enabled device and that mobile device account may be credited with the reward amount.

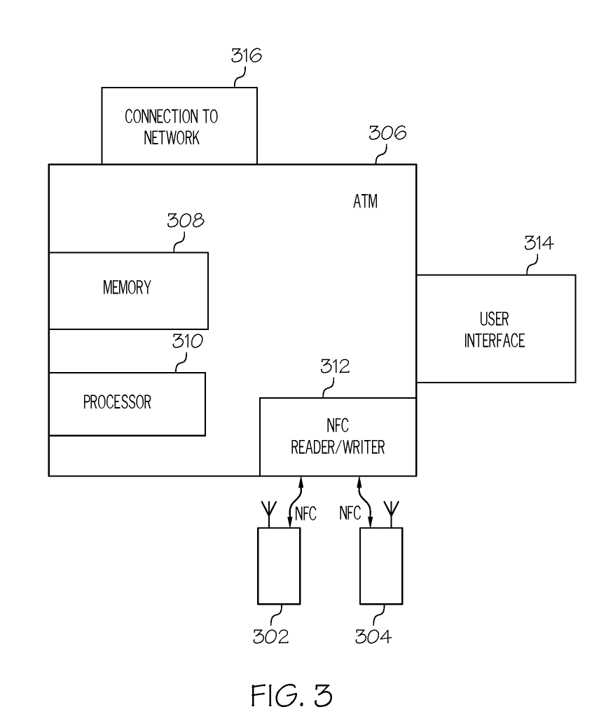

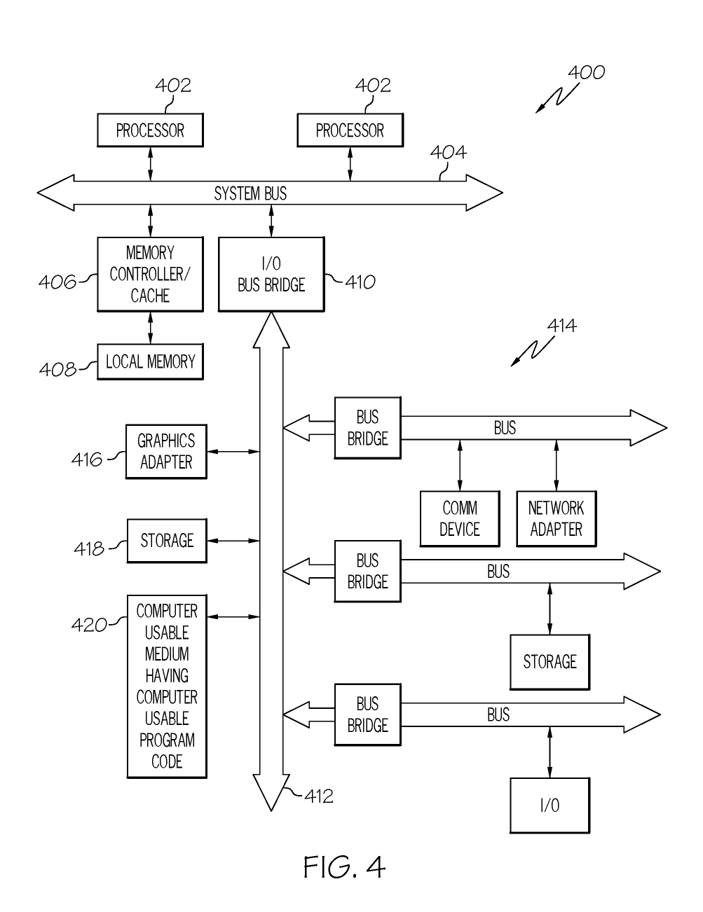

FIG. 3 illustrates an example hardware environment in accordance with the principles of the present disclosure. In the above description, the ATM is described as performing a number of steps but these steps can be performed by separate systems as well. For example, the ATM may be coupled with other computers and processing devices within the financial institution that may separately perform some of the identified steps based on information received by the ATM. The ATM may also be coupled via a network to other financial institutions, banking centers, and transaction clearinghouses so that inter-bank transfers and similar transactions can be performed. Thus, the example hardware illustrated in FIG. 3 is provided merely by way of example and one of ordinary skill will readily recognize that other hardware arrangements can be designed without departing from the scope of the present disclosure. FIG. 4 provides one example of details of a computer that can be a part of the ATM of FIG. 3 and perform the steps identified in FIGS. 1-2B.

The ATM 306 can include a user interface 314 that allows a user to select different operations and choose various menu options offered by the ATM 306. The ATM 306 also includes a processor 310 and a memory 308. The memory 308 can, for example, store executable code that the processor 310 executes to perform the functions of the ATM. As one example, the processor 310 can process the input received through the user interface 314 and control the output that is provided to the user that is using the user interface 314. As mentioned, the ATM 306 may also include a connection 316 that allows it to communicate with other computers or networks so that the ATM 306 can work in conjunction with other computers to perform the functions described herein.

Of particular note, the ATM 306 includes NFC circuitry 312 that allows it to send NFC messages and receive NFC messages. Thus, even though the steps described with respect to FIGS. 1-2B involved the ATM 306 receiving messages from one or more NFC-enabled devices 302, 304, the ATM 306 may also send messages to the devices 302, 304 as well. For example, the NFC app on a device 302, 304 may be designed to specifically communicate with the ATM rather than being a general-purpose NFC app. In this way, the ATM 306 and the app on the device 302, 304 can exchange information in a pre-arranged protocol. The processor 310 operates to receive the messages that the NFC circuitry 312 receives and then process those messages to extract information contained in those messages.

Using the extracted information and other information entered through the user interface 314, the ATM can construct and initiate transactions such as adding a beneficiary to an account, performing an inter-bank funds transfer, or reward a referral account.

Referring to FIG. 4, a block diagram of a data processing system is depicted in accordance with the present disclosure. A data processing system 400, such as may be utilized to implement the hardware platform 306 or aspects thereof, e.g., as set out in greater detail in FIG. 1-FIG. 3, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more buses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 3.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of operating an automated teller machine, comprising:
receiving, via a user interface of the automated teller machine, a first input;
wherein said first input comprises an indication of a transaction type;
detecting, by a near field communication reader of the automated teller machine, a first near field communication message from a first mobile device associated with a first user;
extracting, by the automated teller machine, a first account identification information from the first near field communication message,
wherein said first account identification information comprises data related to a first account associated with the first user;
detecting, by the near field communication reader of the automated teller machine, a second near field communication message from a second mobile device associated with a second user;
extracting, by the automated teller machine, a second account identification information from the second near field communication message,
wherein the second account identification information comprises data related to a second account associated with the second user; and
initiating, by the automated teller machine, a transaction based on the transaction type, the first account identification information, and the second account identification information.

2. The method of claim 1, comprising:
receiving, via the user interface of the automated teller machine, a second input,
wherein said second input comprises data related to a transaction amount.

3. The method of claim 2, wherein the transaction is based on the transaction amount, the transaction type, the first account identification information, and the second account identification information.

4. The method of claim 1, wherein the first account identification information comprises:
a first unique identifier associated with the first mobile device; and
a personal identification number associated with the first user.

5. The method of claim 4, comprising:
determining, by the automated teller machine, the first account to debit funds from as part of the transaction, based on the first account identification information.

6. The method of claim 5, wherein the second account identification information comprises:
a second unique identifier associated with the second mobile device; and
a publicly available identifier associated with the second user.

7. The method of claim 6, comprising:
determining, by the automated teller machine, the second account to credit funds to as part of the transaction, based on the second account identification information.

8. The method of claim 1, wherein the transaction type is one of a) an inter-bank fund transfer to a beneficiary or b) adding a beneficiary.

9. The method of claim 8, wherein the second account information comprises:
a name of the beneficiary;
an address of the beneficiary; and
a second unique identifier of a bank account associated with the beneficiary.

10. The method of claim 9, comprising:
determining, by the automated teller machine, the second account to credit funds to as part of the transaction, based on the second account identification information.

11. A system, comprising:
an automated teller machine comprising:
a) a user interface configured to:
provide user-selectable options;
receive a first input,
wherein said first input comprises data that identifies a transaction type;
b) a near field communication reader configured to:
detect a first near field communication message from a first mobile device associated with a first user; and
detect a second near field communication message from a second mobile device associated with a second user;
c) a processor; and
d) a computer readable storage accessible by the processor and storing code executable by the processor, the code when executed causes the processor to:
extract a first account identification information from the first near field communication message,
wherein said first account identification information comprises data that identifies a first account associated with the first user;
extract a second account identification information from the second near field communication message,
wherein the second account identification information comprises data that identifies a second account associated with the second user; and
initiate a transaction based on the transaction type, the first account identification information, and the second account identification information.

12. The system of claim 11, wherein the user interface is configured to receive a second input,
wherein said second input comprises data that identifies a transaction amount.

13. The system of claim 12, wherein the transaction is based on the transaction amount, the transaction type, the first account identification information, and the second account identification information.

14. The system of claim 11, wherein the first account identification information comprises:
a first unique identifier associated with the first mobile device; and
a personal identification number associated with the first user.

15. The system of claim 14, wherein the code when executed causes the processor to determine the first account to debit funds from as part of the transaction, based on the first account identification information.

16. The system of claim 15, wherein the second account identification information comprises:
a second unique identifier associated with the second mobile device; and
a publicly available identifier associated with the second user.

17. The system of claim 16 wherein the code when executed causes the processor to determine the second account to credit funds to as part of the transaction, based on the second account identification information.

18. The system of claim 13, wherein the transaction type is one of a) an inter-bank fund transfer to a beneficiary or b) adding a beneficiary.

19. The system of claim 18, wherein the second account information comprises:
a name of the beneficiary;
an address of the beneficiary; and
a second unique identifier of a bank account associated with the beneficiary.

20. The system of claim 19 wherein the code when executed causes the processor to determine the second account to credit funds to as part of the transaction, based on the second account identification information.

21. A computer program product for operating an automated teller machine, comprising:
a non-transitory computer readable storage medium having computer readable program code embodied therewith, the computer readable program code comprising:
computer readable program code configured to receive, via a user interface of the automated teller machine, a first input;
wherein said first input comprises data that identifies a transaction type;
computer readable program code configured to detect, by a near field communication reader of the automated teller machine, a first near field communication message from a first mobile device associated with a first user;
computer readable program code configured to extract a first account identification information from the first near field communication message,
wherein said first account identification information comprises data that identifies a first account associated with the first user;
computer readable program code configured to receive, via the user interface of the automated teller machine, a second input,
wherein said second input comprises data that identifies a transaction amount;
computer readable program code configured to detect, by the near field communication reader of the automated teller machine, a second near field communication message from a second mobile device associated with a second user;
computer readable program code configured to extract a second account identification information from the second near field communication method,
wherein the second account identification information comprises data that identifies a second account associated with the second user; and
computer readable program code configured to initiate a transaction based on the transaction type, the first account identification information, the second account identification information, and the transaction amount.
